(19) United States
(12) Patent Application Publication
(10) Pub. No.: US 2007/0272366 A1
(43) Pub. Date: Nov. 29, 2007

(54) Roll-up door assembly

(76) Inventors: Jeffery A. Brunette, Rice Lake, WI (US); Barry J. Brunette, Rice Lake, WI (US)

Correspondence Address: MERCHANT & GOULD PC, P.O. BOX 2903, MINNEAPOLIS, MN, 55402-0903, US

(21) Appl. No.: 11/414,519

(22) Filed: Apr. 27, 2006

(51) Int. Cl. E06B 3/48

(52) U.S. Cl. 160/116

(57) ABSTRACT

A roll-up door having a smaller service door therein is provided. The smaller service door pivots about a vertical hinged edge and enables an operator to move through the roll-up door more efficiently via the smaller and more convenient service door. According to one embodiment of the invention, a self-locking assembly is provided on the free end of the service door for holding together the free end of the service door so that it moves together as a single unit when the service door is in use. A method of manufacturing a roll-up door having a service door therein is also provided.

### FIELD OF THE INVENTION

This invention relates generally to a roll-up door structure and in particular to a roll-up door or overhead door having a swinging door therein.

### BACKGROUND

Roll-up doors are commonly found on trucks, trailers, garages, and industrial buildings. These types of doors typically include a series of pivotally connected horizontal extending panels that ride along a pair of generally L-shaped tracks. The doors are typically configured so that they open by rolling the door up along the tracks and close by rolling the door down along the tracks. The door includes a number of panels to enable the door to bend around the corners of the L-shaped tracks.

Roll-up doors are commonly used to enclose large openings where a standard hinged swinging door would be cumbersome or otherwise be impractical. In buildings, it is common to find an ordinary hinged door positioned near the roll-up door. The hinged door is designed for the convenient and efficient entry and exit of personnel while the roll-up door is designed for the convenient and efficient entry and exit of freight and vehicles. Since the roll-up door is typically large, it requires more effort to open and close the larger roll-up door than a smaller swinging hinged door. In addition, since the temperature within the structure is often controlled, it is more energy efficient to use the smaller door when possible. Therefore, it is typically more efficient for people to use the swinging door rather than the roll-up door when accessing or exiting the structure.

Trucks and trailers having roll-up doors typically do not have the space to include separate smaller swinging hinged doors adjacent and in addition to the roll-up door. However, such a door would be advantageous in vehicles for the same reason it is advantageous in the building structure context. A smaller door would lessen the strain on the operator as he or she would be able to avoid opening the heavier roll-up door when such a large opening is not needed. In addition, where the internal temperature of the truck or trailer is controlled, energy loss would be decreased by use of a smaller swinging door, as the large roll-up door would not be opened as frequently.

To address this need certain roll-up doors have been developed that include smaller swinging doors as an integral part thereof. Exemplary roll-up doors for use with building structures including a smaller swinging door, commonly referred to as a service door, are disclosed in U.S. Patent Publication No. 2003/0141023 to Griebel; U.S. Pat. No. 6,006,814 to Dalpe; U.S. Pat. No. 5,673,740 to Park; U.S. Pat. No. 4,603,723 to Sugihara; U.S. Pat. No. 2,759,227 to Reid et al.; and U.S. Pat. No. 1,989,658 to McCloud. Nonetheless, there is a need in the art for an improved roll-up door that includes a service door. In particular, there is a need in the art for such a door that is particularly well suited to be used on a commercial vehicle, which is subjected to a more rugged environment that is not typically present for doors used with non-mobile building structures.

### SUMMARY OF THE INVENTION

The invention provides a roll-up door that includes a smaller more efficient service door therein. According to one embodiment of the invention, the service door pivots open and closed about a hinged edge while the opposing free edge is secured together by a self-locking assembly. According to one embodiment of the invention, the self-locking assembly includes a segmented bar that self aligns and forms a rigid support member for supporting the free end of the service door while the service door is in use. According to another embodiment of the invention, a method of manufacturing or retrofitting a roll-up door to include a service door therein is also provided.

### BRIEF DESCRIPTION OF THE DRAWINGS

FIG. 1 is a back view of the outside of a truck freight storage area including a roll-up door according to one embodiment of the invention, the service door is shown in a closed position;

FIG. 2 is a back view of the truck shown in FIG. 1 illustrating the service door in an open position;

FIG. 3A is a view of the roll-up door of FIG. 1 as viewed from inside the truck body;

FIG. 3B is an enlarged view of the section of the roll-up door of FIG. 3A referenced as 3B;

FIG. 3C is an enlarged view of a portion of the transverse support member shown in FIG. 3A;

FIG. 4 is a left side view of a portion of the service door of FIG. 1 illustrated as how it would appear when the roll-up door is in a partially open position;

FIG. 5 is an enlarged front view of a portion of one panel of the roll-up door of FIG. 1, illustrating the free end securing assembly portion thereof in more detail;

FIG. 6 is a schematic bottom view of the portion of the roll-up door panel shown in FIG. 5 as it would generally appear when viewed from the line 6-6 in FIG. 5, with the latch shown in an engaged position;

FIG. 7 is a schematic bottom view of the latch portion of FIG. 6 with the latch shown in a disengaged position;

FIG. 8 is an enlarged front view of a portion of one panel of the roll-up door of FIG. 1, illustrating an alternative embodiment of the free end securing assembly portion thereof;

FIG. 9 is an enlarged front view of a portion of one panel of the roll-up door of FIG. 1, illustrating a third alternative embodiment of the free end securing assembly portion thereof;

FIG. 10 is an enlarged front view of a portion of one panel of the roll-up door of FIG. 1, illustrating a fourth alternative embodiment of the free end securing assembly portion thereof;

FIG. 11 is a front view of an alternative embodiment of a roll-up door of the invention, as viewed from the back or outside of a truck storage area, illustrating the service door portion thereof in a closed position and illustrating a fifth alternative embodiment of the free end securing assembly portion thereof;

FIG. 12 is a left side view of a portion of the service door of FIG. 1I illustrated as how it would appear when the roll-up door is in a partially open position;

FIG. 13A is an enlarged fractional view of the double acting spring assembly portion of the free end securing assembly of FIG. 12 illustrated in a contracted position;

FIG. 13B is an enlarged fractional view of the double acting spring assembly portion of the free end securing assembly of FIG. 12 illustrated in an extended position;

FIG. 14 is a diagrammatic top end view of the service door portions of the roll-up door of FIG. 1, illustrating positioning of a perimeter seal member relative thereto;

FIG. 15 is an enlarged end view of the door seal portion of FIG. 14;

FIG. 16 is a perspective view of an elongated longitudinal section of the door seal member of FIGS. 14 and 15 with portions thereof broken away, and as viewed generally from the direction “X” in FIG. 14; and

FIG. 17 is a diagrammatic cross-sectional view of a portion of the roll-up door of FIG. 14, as generally viewed along lines 17-17 of FIG. 14, illustrating the door seal segments attached to the plurality of door segments forming the service door.

### DETAILED DESCRIPTION

A roll-up door is shown in the figures and described herein. The roll-up door includes a service door therein that is constructed to swing open and closed about a vertical axis like a typical entry and exit door. However, unlike typical doors, which ordinarily comprise unitary constructions, the service door is constructed of a plurality of hinged sections of panels attached to allow the roll-up door to bend when the roll-up door opens and closes. The invention provides novel structure, which enables the service door in the roll-up door to function like an ordinary swinging door yet bend with the rest of the roll-up door when the roll-up door is opening or closing. In addition, a method of manufacturing a roll-up door and a method of retrofitting a roll-up door including a service door therein are also provided according to the invention.

While the invention will be described with embodiments of the invention that are exemplified for use with a truck body door, it should be understood that the principles of the invention are not limited to vehicle applications, but could be applied to roll-up and overhead door configurations for buildings or portions thereof.

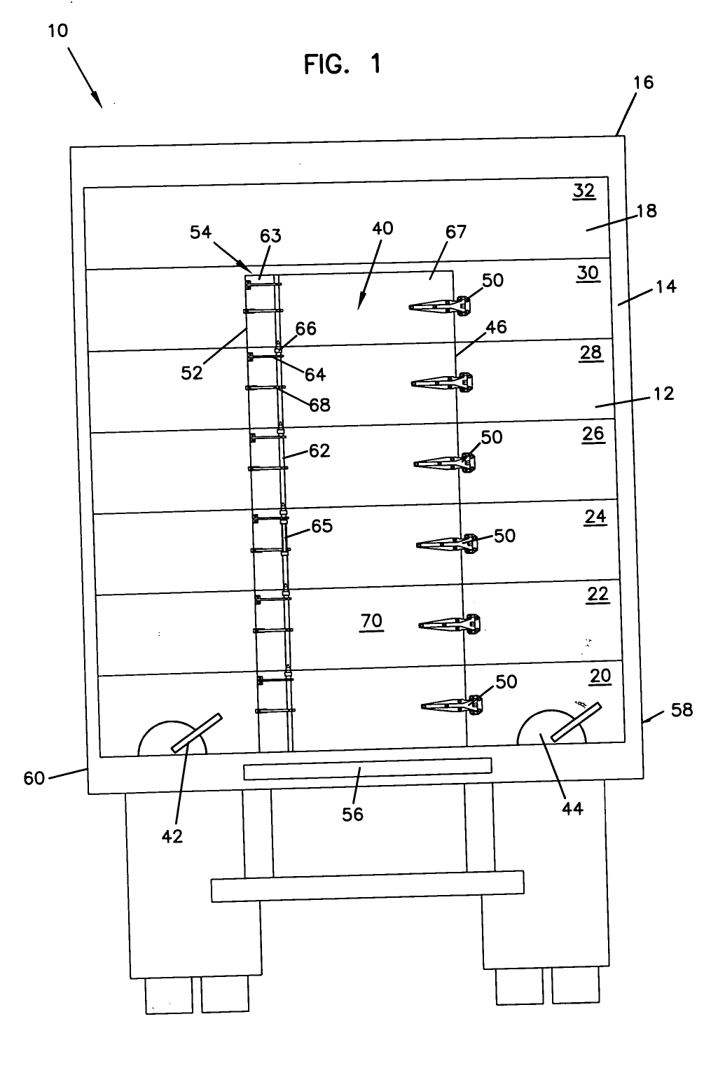

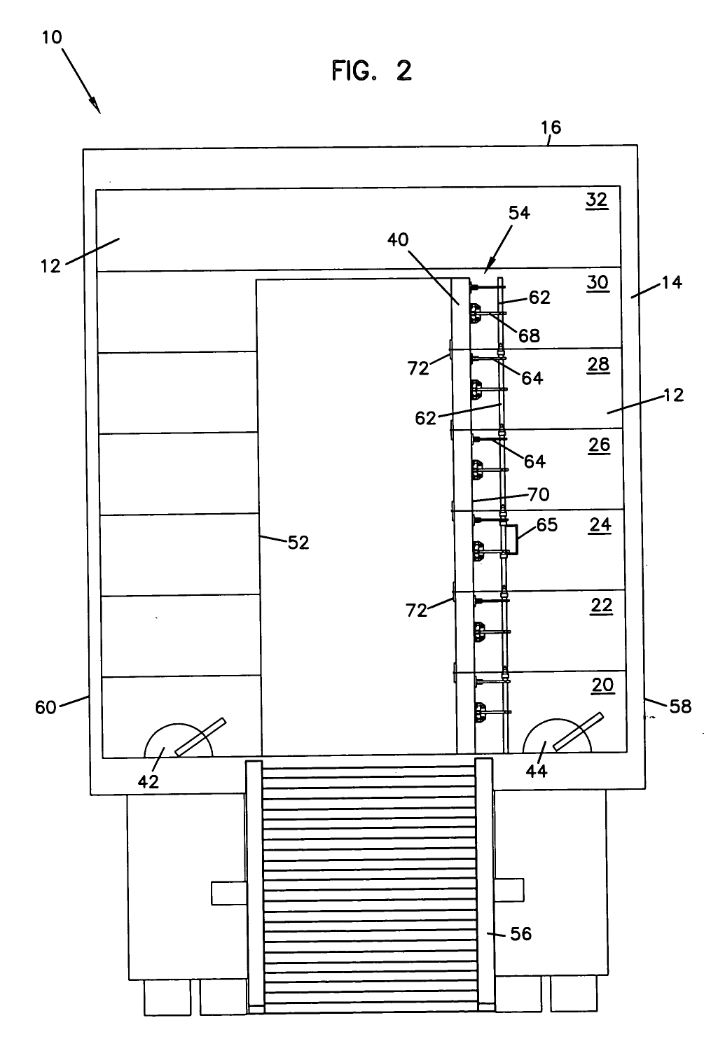

Referring to the figures wherein like numerals represent like parts throughout the several views, in FIGS. 1 and 2, a back view of a truck 10 having a roll-up door 12 is shown. The roll-up door is shown in the closed position in FIG. 1. In the closed position the roll-up door encloses the back end 14 of the truck. In the open position (not shown) the roll-up door is typically positioned inside the truck body along the roof 16 of the truck.

In the depicted embodiment, the roll-up door 12 includes seven generally rectangular panels 20, 22, 24, 26, 28, 30 and 32. A service door 40 is formed from portions of the roll-up door panels and is positioned to align with the pull-out ramp 56 located midway between a first side 58 and a second side 60 of the truck 10. The pull-out ramp 56 is shown operatively extended in FIG. 2. A pair of locking latches 42, 44 are mounted to the lower panel 20 of the roll-up door 12 and are positioned on either side of the service door 40. The locking latches 42, 44 are pivotal, as well known in the art, to secure the bottom of the roll-up door to the bottom floor or frame member of the truck body. The service door is formed or “cut” from central portions of the roll-up door panels. The service door is hinged along a first longitudinally vertical seam or edge 46. In the embodiment shown, the service door is formed from portions of six of the roll-up door panels. It should be understood, however, that the number of roll-up door panels used to form the service door can be two or more, with the number being determined by the desired height of the service door and the height(s) of the roll-up door panels. Each of the six rectangular panels 20, 22, 24, 26, 28, and 30 includes a hinge 50 connecting each panel member to itself along the service door edge 46 to enable the service door 40 to open by swinging outwardly as shown in FIG. 2, which enables the operator to conveniently enter and exit the cargo area of the truck 10 body.

Adjacent a second longitudinal vertical seam 52 in the roll-up door panels, and supporting the free edge of the service door, is a free end securing assembly 54. The free end securing assembly 54 includes a bar 62 that extends generally parallel to the second longitudinal vertical edge 52. The bar 62 is constructed of multiple sections that lock together to hold the free side 63 (as opposed to the pivot side 67) of the door together as a single unit. Attached to the bar 62 are a plurality of pivot supports 64, collars 66, and latches 68. The bar 62 is pivotally connected to the outside panels adjacent the second vertical seam 52 by the pivot support 64. In the embodiment illustrated there is one pivot support 64 connected to each of the panels 20, 22, 24, 26, 28 and 30 forming the service door. Similarly, there is one latch 68 pivotally connected to the bar 62 for each of the panels 20, 22, 24, 26, 28 and 30. The latches, described in more detail hereinafter, releasably secure the service door panels at the free side 63 of the door to their respective adjacent roll-up door panel portions, in response to pivotal motion of the bar 62 about the pivot support 64. The free end securing assembly 54 is configured such that it holds the service door 40 closed when the bar 62 is pivotally biased towards the outside surface 70 of the service door 40 as shown in FIG. 1, and allows the service door 40 to swing open when the bar 62 is pivoted away from the outside surface 70 of the service door 40 as shown in FIG. 2. The depicted embodiment of the free end securing assembly 54 and alternative embodiments of the assembly are described in greater detail below.

It should be appreciated that according to the invention many alternative embodiments of the roll-up door 12 and its associated service door 40 are possible. For example, the roll-up door 12 may include any number of panels in any workable geometric configuration. The service door 40 within the roll-up door could alternatively be located off to one side or another. Moreover, the service door 40 may include more or fewer hinges, and the hinges can be positioned in many different locations. For example, in an alternative embodiment each panel forming the service door may be connected to the roll-up door panels by one or two hinges (not shown) located adjacent the inside edge of the service door 40 such that the service door 40 is configured to open inwardly.

It should also be appreciated that the roll-up door 12 can be configured to be used in many other environments. In an alternative embodiment the roll-up door 12 can be configured to be used on a truck having a hydraulic loading platform (lift gate) in place of the ramp 56. In other embodiments the roll-up door 12 can be configured, for example, to be used in industrial building settings or as a garage door of a residential building.

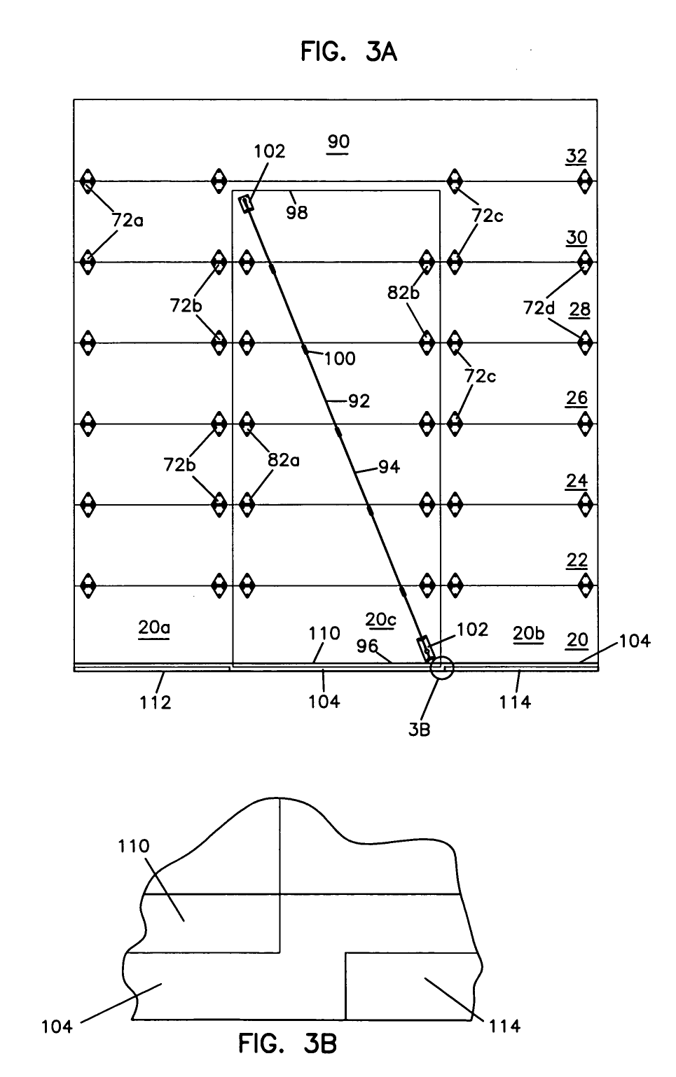

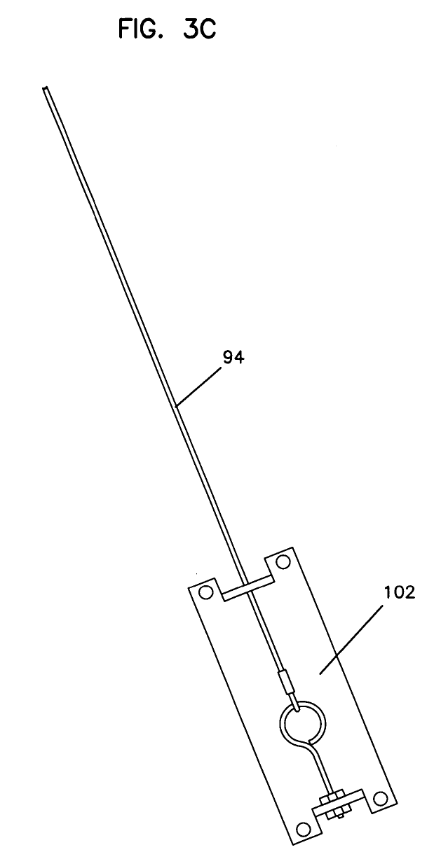

Referring to FIGS. 3A-C, the roll-up door 12 is shown from inside the truck 10 body. In the depicted embodiment the panels 20, 22, 24, 26, 28, 30 and 32 are shown pivotally connected via a plurality of hinges 72 and 82. Those portions of adjacent roll-up door 12 panels located outside of the service door perimeter are connected by four columns of hinges 72a, 72b, 72c and 72d. These hinges collectively interconnect the panels to form a solid surrounding framework for the service door 40 when the roll-up door is closed or down as shown in FIG. 3A. The adjacent panels 20, 22, 24, 26, 28, 30 and 32 of the roll-up door 12 that also form the service door 40 are connected by two columns of hinges 82a and 82b aligned adjacent the outer lateral edges of the service door. The hinges 72 and 82 are connected to the inner surface 90 of the roll-up door. The hinges 82 interconnect the service door panels for vertical movement with the roll-up door and enable the service door to form a solid door panel when pivotally swung about a vertical axis, as hereinafter described in more detail. It should be appreciated that in alternative embodiments, any number and arrangement of hinges may be possible.

Still referring to FIGS. 3A-C, the service door 40 includes a transverse support mechanism 92. The transverse support mechanism 92 includes a cable 94 that is connected near a lower corner 96 and near an opposed upper corner 98 of the service door 40. The cable 94 can be tensioned to provide auxiliary support to the service door 40. In the depicted embodiment each end of the cable includes a threaded tensioning member 102 that can be twisted to tighten or loosen the cable 94. In addition, along the cable 94 are guide members 100 that attach to the inner surface 90 of the service door 40 and hold the cable in place along the panels of the service door 40. It should be appreciated that alternative embodiments of the service door may include no transverse support mechanism 92 or alternative embodiments of such support mechanisms.

The roll-up door 12 also includes a base plate 104 that connects the left most portion 20a of the panel 20 to the right most portion 20b of the panel 20. The base plate 104 is downwardly notched to be positioned adjacent the truck body floor and to extend underneath a wiper seal 110 of the service door 40 mounted near the lower edge of the lowest service door panel 20c. In some embodiments the downwardly notched portion of the base plate 104 includes chamfered edges to facilitate the rolling of two wheel carts into and out of the service door 40. Chamfered edges can also prevent operators from tripping on the base plate 104. The wiper seal 110 seals the gap between the bottom edge of the service door panel 20c and the base plate 104 when the service door and roll-up door are closed. A pair of seal members 112 and 114 are connected respectively to or adjacent the base plate 104 portions extending beneath the left most and right most panel portions 20a and 20b to form seals of such panel portions with the floor of the truck body when the roll-up door 12 is closed.

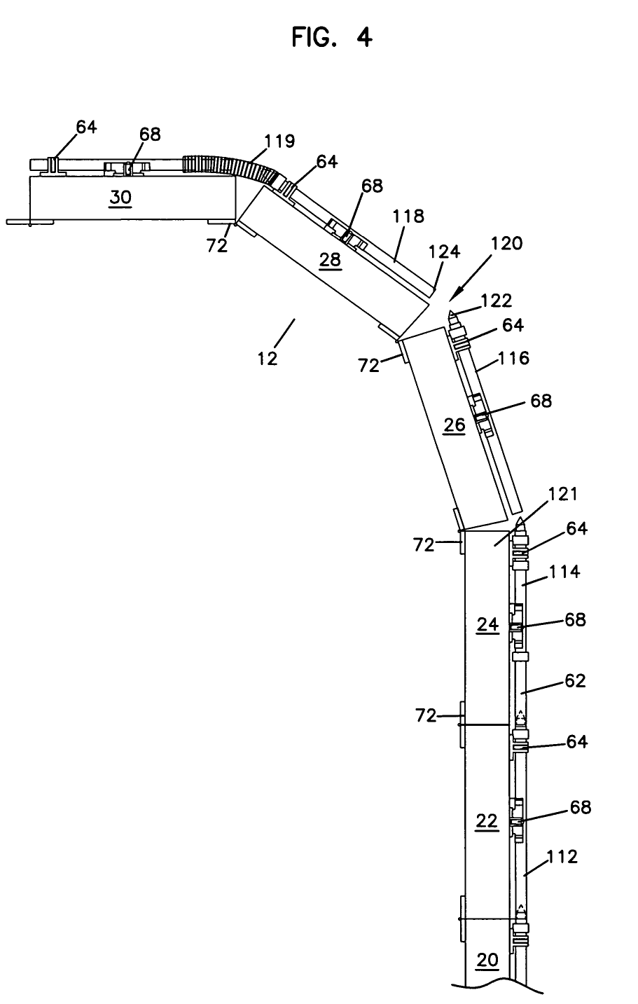

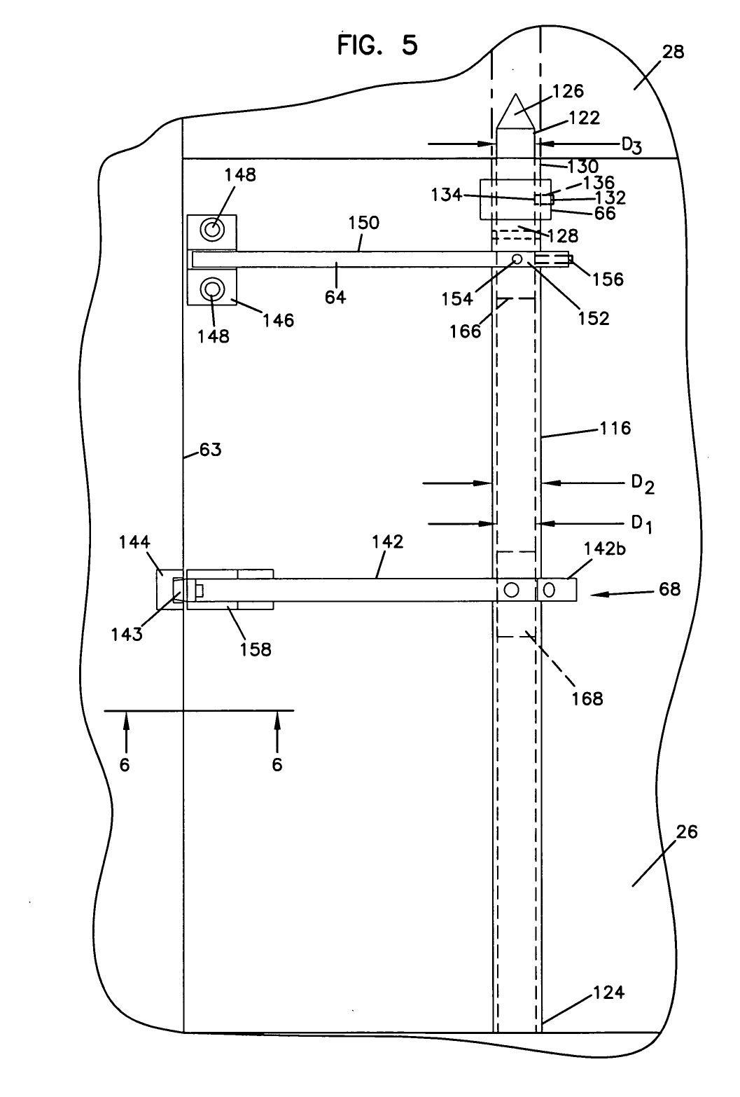

Referring to FIGS. 4 and 5, the embodiment of the free end securing member 54 of FIGS. 1 and 2 is shown in greater detail. Referring to FIG. 4, the free end securing member 54 is shown in a position where the roll-up door 12 is partially open. In the first embodiment bar 62 is a segmented bar having a plurality of vertical interlocking segments or sections. For numbered bar 62 segments 112, 114, 116, and 118 are illustrated in FIG. 4 as being operatively associated with and connected to service door 40 panel members 22, 24, 26 and 28 respectively. The sections 112 and 114 of the bar 62 are shown locked together in FIG. 4, whereas sections 116 and 118 are shown separated. As the panels 20, 22, 24, 26, 28, 30 and 32 of roll-up door 12 move upward along the curved portion of the tracks of the roll-up door (not shown, but well understood by those skilled in the art), the panels 20, 22, 24, 26, 28, 30 and 32 forming both the roll-up door 12 and the service door 40 pivot about hinges 72 and 82, and the outer surfaces 70 of the panels 20, 22, 24, 26, 28, 30 and 32 separate. As the outer surfaces 70 of the panels 20, 22, 24, 26, 28, 30 and 32 separate, adjacent sections 112, 114, 116 and 118 of the bar 62 also separate. Conversely, as the outer surfaces 70 of the panels 20, 22, 24, 26, 28, 30 and 32 come together, the sections 112, 114, 116 and 118 of the bar 62 interlockingly mate with one another to form a continuous rigid longitudinal bar. In the depicted embodiment a sleeve 119 may be positioned over the sections 112, 114, 116 and 118 of the bar 62 to protect the operator from being injured from the moving parts and to protect the moving parts from the environment. In the depicted embodiment the side edges of the panels 20, 22, 24, 26, 28, 30 and 32 are finished with edge caps 121. The edge caps 121 can be used to enclose the otherwise exposed cut edge of the roll-up door 12 in embodiments where the free end securing member 54 is retrofitted onto a standard roll-up door. In should be understood that in alternative embodiments the roll-up door may include less or more features. For example, an alternative embodiment of the roll-up door may not include the sleeves 119 or the edge caps 121.

Each of the adjacent sections 114, 116 and 118 of the bar 62 includes a self-guiding locking mechanism 120 that releasably holds adjacent sections 112, 114, 116 and 118 of bar 62 together except for the upper most section 112, as the post 122 would not serve a function. In the depicted embodiment, the locking mechanism includes a post 122 mounted to the upper end of a post segment that is sized to cooperatively engage the lower portion 124 of the adjacent section 112, 114, 116 and 118 of bar 62. More particularly, the bar 62 in the depicted embodiment is hollow, having a circular cross-section with an inner diameter D1 and an outer diameter D2. In the depicted embodiment the sections 112, 114, 116 and 118 of the bar 62 have a constant inner diameter D1 and outer diameter D2.

As illustrated in FIGS. 4 and 5, the post 122 of section 116 includes a diameter D3 that is slightly smaller than D1 so that the post can slidably fit within the lower portion 124 of bar section 118. The post 122 includes a guide portion 126 at the distal end of the post 122. The guide portion is conical in shape so that the post 122 can properly engage the lower portion 124 of the adjacent section 118 of bar 62 even if they are slightly misaligned.

The proximal end 128 of the post 122 is configured to fit within the upper end 130 of section 116 of the bar 62. To hold the post 122 in place within the section 116 a collar 66 is positioned over the outside of the upper end 130 of section 116 of the bar 62. The collar 66 supports a threaded set screw 132 that includes a bearing end 134 that fits through a hole 136 in the upper end 130 of section 116 of the bar 62 and engages the body of the post 122 securing the longitudinal position of the post 122 within the bar segment. The collar 66 further allows the longitudinal position of the post 122 to be axially adjusted as necessary to insure proper cooperative engagement with the bottom 124 of the next adjacent bar segment. A similar self guiding locking mechanism is present at the junctions of each pair of adjacent segments of bar 62. It should be understood that many alternative embodiments of locking mechanism 120 are possible. A few such alternative embodiments will be discussed in greater detail below.

Referring to FIGS. 4-7, the plurality of interconnecting sections 112, 114, 116 and 118 of the bar 62 are secured to the outer surfaces 70 of the panels of the service door by a plurality of hinged pivot support members 64 and latches 68. When fully engaged the latches 68 secure the service door 40 in a closed position as shown in FIGS. 1, 5 and 6. In such closed position, the service door panel members form a continuous part of the respective roll-up door panels and move with the roll-up door panels as though the service door did not exist. In the disengaged position the latches 68 allow the service door 40 to act independent of the roll-up door panels and to swing open as shown in FIGS. 2 and 7.

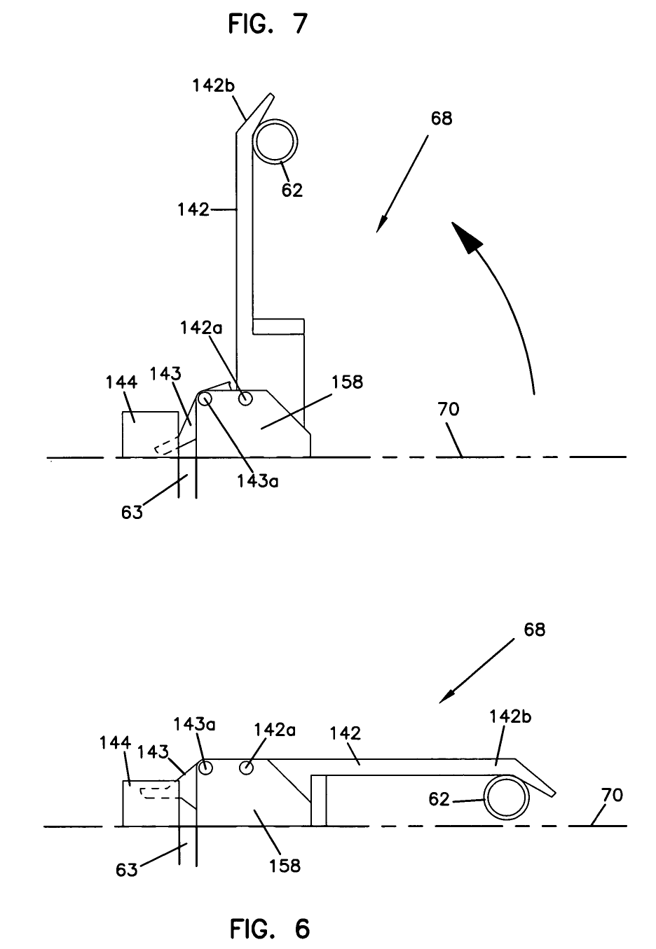

Each latch 68 includes an over center lever portion 142 pivotally connected to a base member 158 that is secured to the service door panel adjacent its free side edge 63. The lever arm 142 pivots about a pin 142a between a closed latched position as shown in FIG. 6 and an open unlatched position as shown in FIG. 7. The end of the lever arm 142 adjacent its pivot axis has a cammed surface that pivotally toggles a cam dog member 143 that rotates about a pivot axis 143a. The cam dog member 143 extends across the gap between the edge of the service door panel and the adjacent edge of the roll-up door panel to slidably engage a mating surface of an aligned catch member 144 that is secured to the outer adjacent panel surface 70 of the roll-up door. The cam dog member rotates as urged by the lever arm 142, between a fully latch position as shown in FIG. 6, to an unlatched position as shown in FIG. 7. The free end 142b of the lever arm 142 is secured to a segment of the bar 62 and moves therewith as described below. In embodiments shown, the free end 142b of the lever arm 142 is bolted to the bar segment 62 as shown in FIG. 5. Such latch mechanisms 68 as described above are commercially available from http://www.southco.com/ and are sold under the designation of A7style Over-Center Lever Latches.

The bar 62 segments are further aligned on and secured to the outer surface 70 of the service door panels by the hinge support members 64 (FIG. 5). The hinge support members 64 include a base 146 that is fixedly secured to the outer surface 70 of the service door panel adjacent the free side 63 of the service door panel. In the embodiment illustrated, the base 146 is secured to the door panel by a pair of bolts 148. The base 146 mounts the pivot pins (not shown) about which an arm member 150 pivots. The axis of the pivot pin for the base 146 is generally vertically aligned with the pivot axis for the lever arm 142 such that the two pivot points form a common pivot axis for the lever arm 142 and the arm member 150. The free end of the arm member 150 defines an aperture 152 sized to slide over and house a portion of the bar 62, as shown in FIG. 5. The bar 62 is secured to the arm member 150 via a pair of set screws 154 and 156. In the depicted embodiment the set screws 154 and 156 are at right angles relative to each other such that when they are tightened they bias the bar 62 towards the opposed portion of the aperture 152 of the arm member 150.

In some embodiments support slugs 166 and 168 are inserted into the bar 62 at the locations where the bar connects to the hinge support members 64 and latches 68. The slugs 166 and 168 are sized, constructed, and positioned to provide structural support to such areas of the bar 62 to prevent the bar from crushing or dimpling at the connection locations. In the depicted embodiment the bar 62 is a ¾ inch hollow cylindrical steel bar. Any number of alternative materials, sizes, and shapes of bars can be used as well.

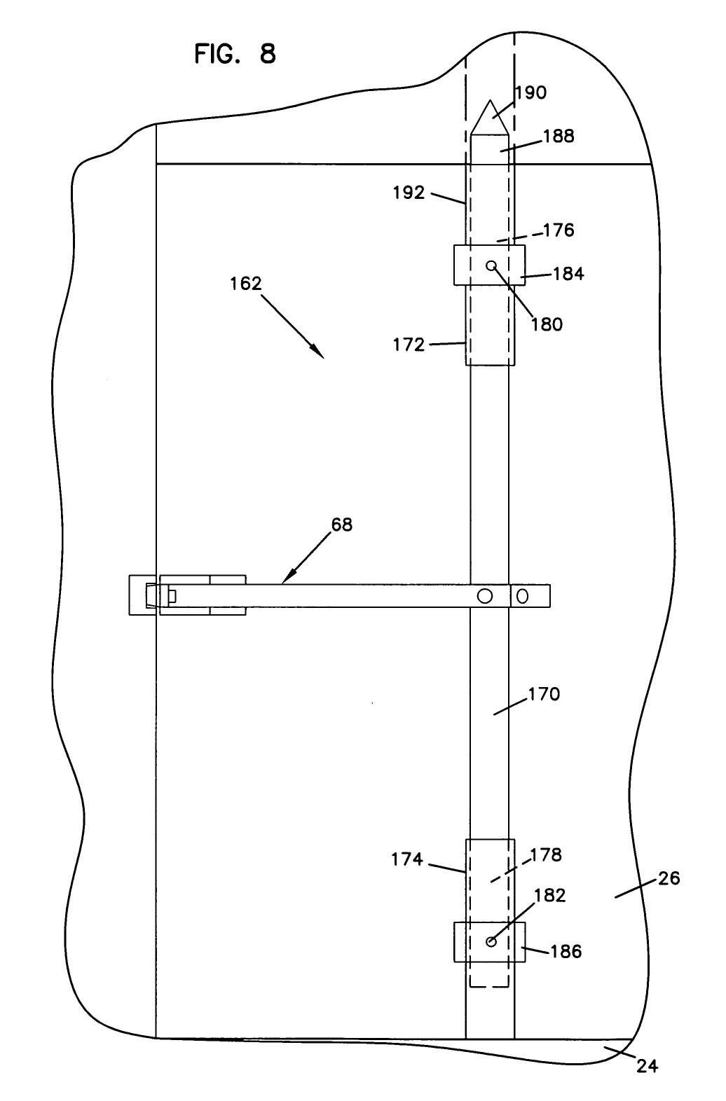

Referring to FIG. 8, an alternative embodiment of the free end securing member 54 is shown at 162. The free end securing member 162 includes the latch 68 of the type previously described attached to a solid bar segment 170. The bar 170 functions in a manner similar to bar 62 previously described, except for its end connections to adjacent bar segments. Upper and lower hollow bar coupling members 172 and 174 are positioned over an upper end portion 176 and a lower end portion 178 of the bar 170 such that the hollow bars 172 and 174 slidably overlap the solid bar 170. The hollow bars 172 and 174 are secured to the solid bar 170 via set screws 180 and 182 threadably supported in a pair of collars 184 and 186 overlying the coupling members 172 and 174. In the depicted embodiment a post 188 having a conical guide tip 190 is secured to the upper end 192 of the upper hollow bar 172. Post 188 is similar in function to post 122 previously described. In should be appreciated that the post 188 could alternatively be connected to extend downwardly from the lower hollow bar 174, and the upper hollow bar 172 can be configured to receive a post of the locking mechanism attached to the bar segment of the adjacent above panel.

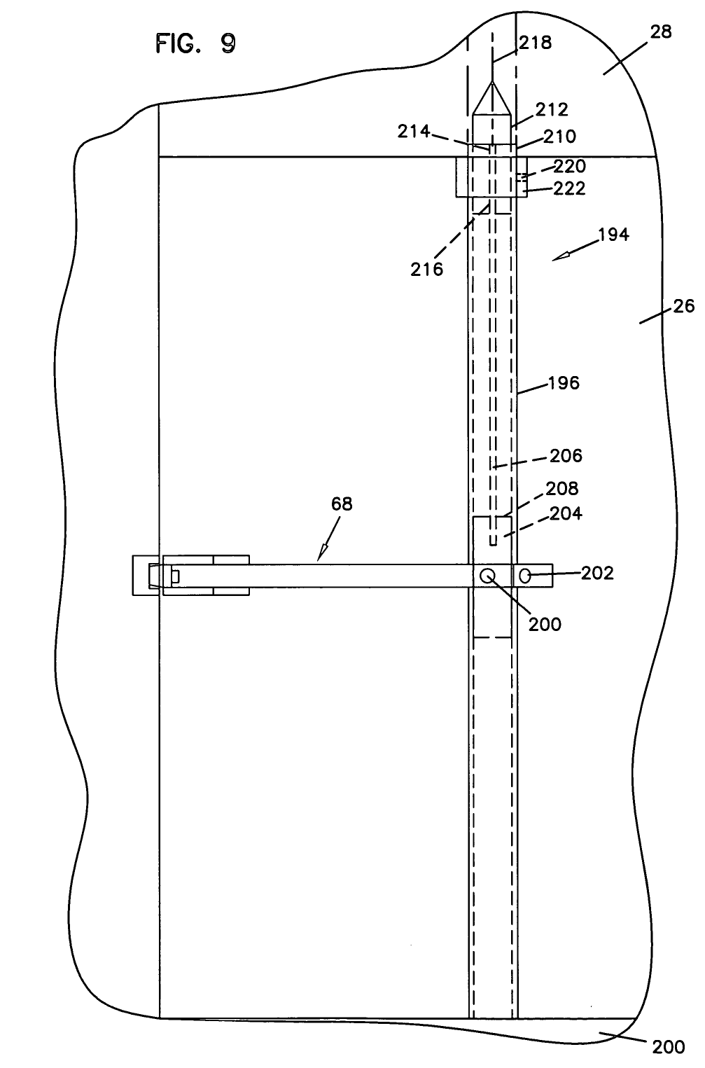

Referring to FIG. 9, a third alternative embodiment of the free end securing member 54 is shown at 194. The free end securing member 194 includes a hollow bar segment 196 that is attached to the latch 68 via two mechanical fasteners 200 and 202, which engage the latch 68, the bar 196, and a slug 204 positioned within the bar 196. The bar 196 functions to support the service door in a manner similar to that of the bar 62 previously described. In some embodiments holes are drilled through the bar 196 and into the slug 204 for receiving the fasteners 200 and 202. In should be appreciated that in alternative embodiments the bar 196 can be connected to the latch 68 via other means. For example, the bar 196 could be welded to the latch 68.

In the depicted embodiment the slug 204 includes a rod 206 that is connected to and extends from the top portion 208 of the slug 204 towards the upper end 210 of the bar 196. The bar 196 is constructed to engage a post 212 such that the longitudinal position of the post 212 relative to the bar 196 can be adjusted by moving the post 212 along the rod 206. In the depicted embodiment, the upper end 214 of the rod 206 is threaded, and the bottom of the post 212 includes a threaded hole 216 that engages the upper end 214 of the rod 206. The vertical position of the post 212 in the depicted embodiment can be adjusted by twisting the post about its central axis 218. Once the desired vertical position of the post 212 is set, the post 212 can be further secured to the bar 196 by tightening the set screw 220 on the collar 222. Post 212 operatively functions similar to post 122 previously described.

Referring to FIG. 10, a fourth alternative embodiment of the free end securing member 54 is shown at 238. In the depicted embodiment the free end securing member 238 includes a spacer 224 positioned within a bar segment 230 between a slug 226 and a post 228. In addition, a spring 236 is positioned within the bar segment 230 and biased between the slug 226 and the post 228. The bar segment 230 and post 228 operate in similar manner to the bar 62 and post 122 member previously described. In the illustrated embodiment, the longitudinal position of the post 228 can be conveniently adjusted by loosening the set screw 232 on the collar 234 and pressing the post 228 down against the spring 236 until the post 228 is in the desired position. Then the set screw 232 is tightened to secure the post 228 in the desired position relative to the bar 230. In the depicted embodiment the spring 236 prevents the post from falling into the bar 230 when the set screw 232 is loosened.

It should be appreciated that any disclosed feature of the free end securing member of one embodiment may be combined with the features of disclosed alternative embodiments to form additional alternative embodiments. In addition, numerous other alternative embodiments not specifically shown or described are also within the scope of the invention.

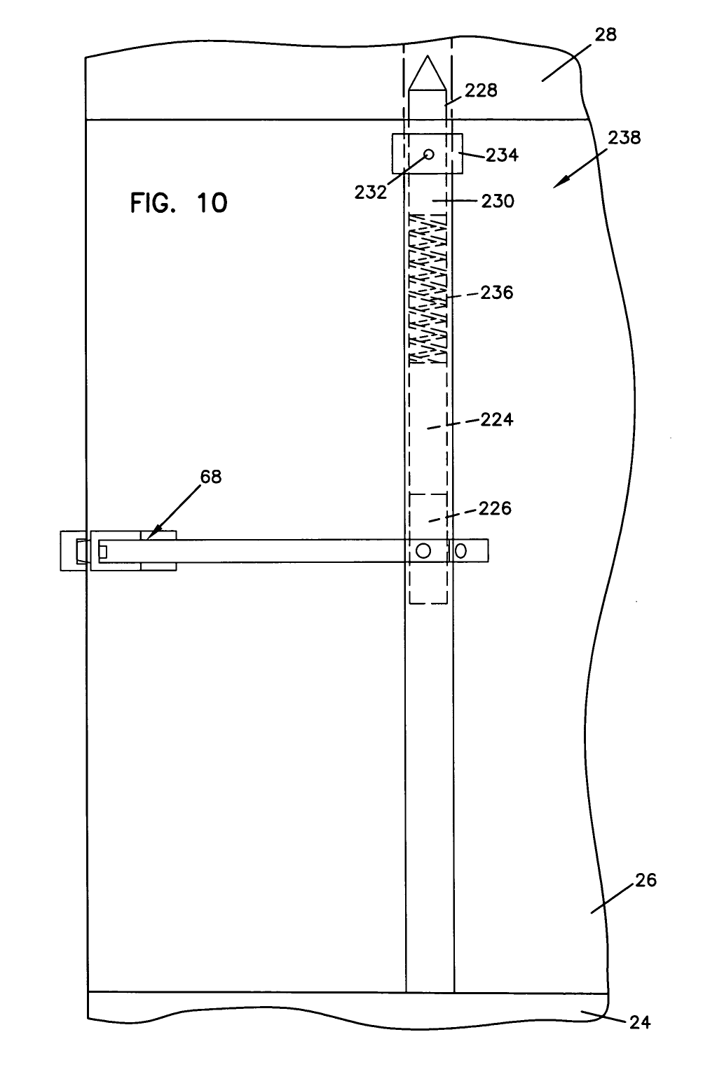

Referring to FIG. 11, a fifth alternative embodiment of the free end securing member 54 is shown at 240. The free end securing member 240 includes a sectioned bar 242 that is secured for rotational movement to a lever arm 244 that can be secured to the service door 40 via a lock 248. The service door 40 is shown as part of a roll-up door 12 that is similar to the roll-up door described above including a number of panels 20, 22, 24, 26, 28, 30 and 32 and a pair of locking latches 42 and 44. In the depicted embodiment, the lever arm can be removed from the lock 248 and pivoted away from the service door 246 thereby causing the sectioned bar 242 to rotate clockwise as viewed from above about its center axis 250. Rotating the sectioned bar 242 causes the lugs 252 attached to the bar 242 to slide out of the keepers 243 that are fixed to the non-service door portion 256 of the roll-up door 12 thereby releasing the service door 246 from the non-service door portion 256 of the roll-up door 12. The portions of the sectioned bar 242 and associated lugs 252 and lever arm 244 are commercially available from http://www.polarmfg.com and are sold under the designation of Polar Holdtite Door Locks.

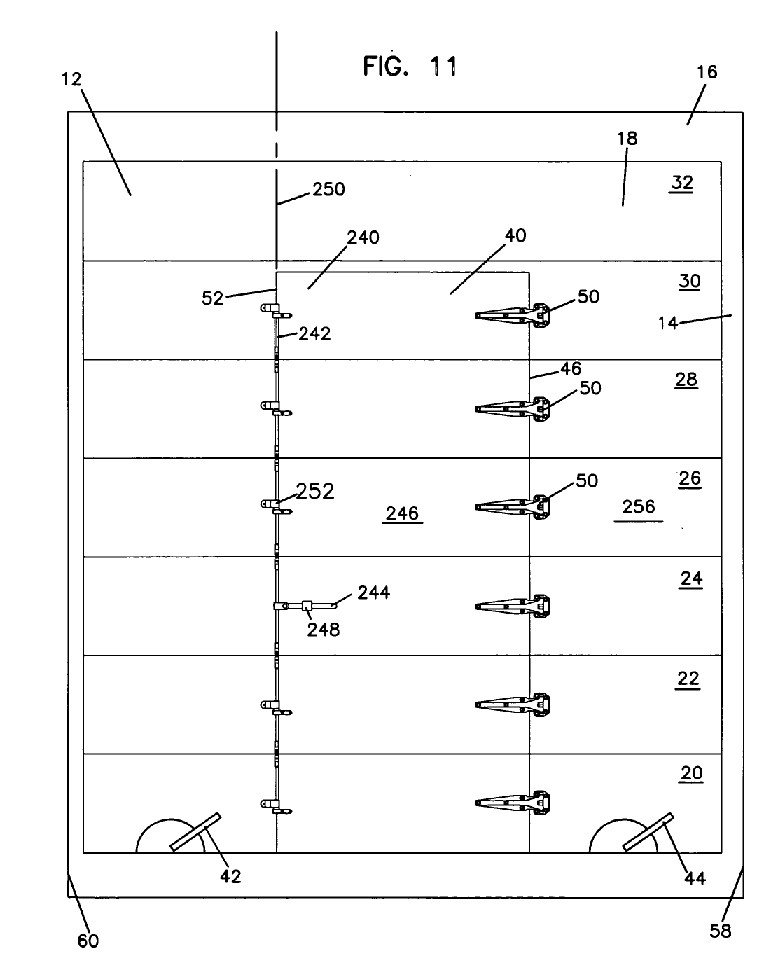

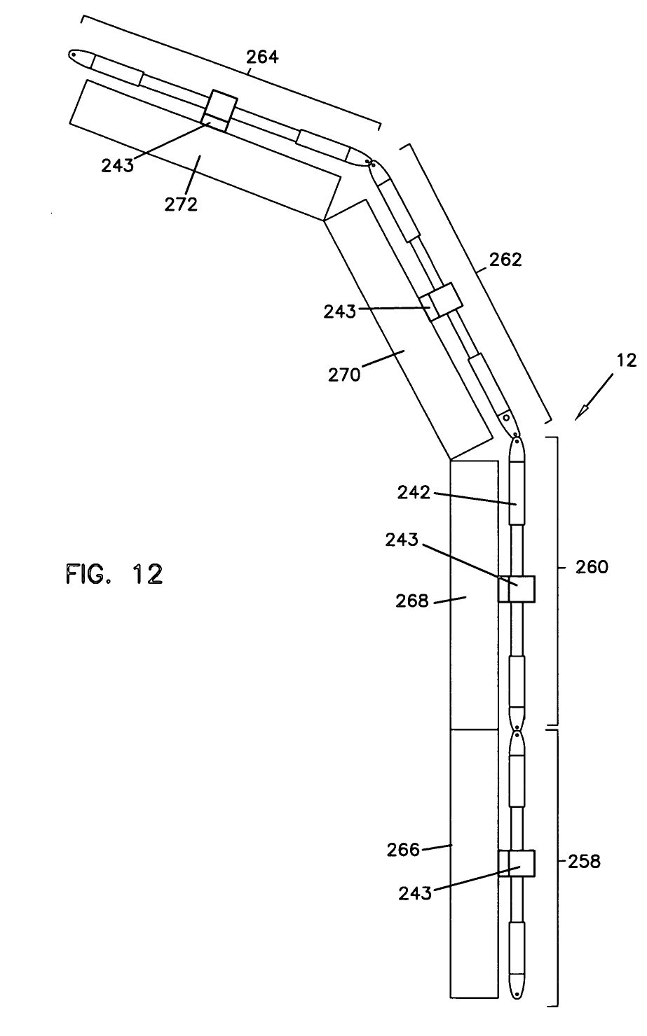

Referring to FIG. 12, the sectioned bar 242 is shown on the service door 40 as the roll-up door 12 is in a partially open position. The sectioned bar 242 includes separate units 258, 260, 262, 264 that are attached to the service door panels. The effective length of each unit 258, 260, 262, 264 is configured to change depending on its position of the panels 266, 268, 270, 272 relative to the tracks (not shown). In other words, each unit 258, 260, 262, 264 is configured to compress or stretch as the roll-up door 12 opens and closes. For example, in the depicted position unit 262 is stretched and unit 258 is compressed.

Referring to FIGS. 13A and 13B, a portion of first and second units 258 and 260 of the double acting spring sliding member are shown in a bent expanded position (FIG. 13B) and a straight contracted position (FIG. 13A). A hinge universal joint 274 connects end portion 276 of unit 260 and end portion 278 of unit 258. The universal joint 274 allows the units 258 and 260 to bend when the panels 272, 270, 268 and 266 of the roll-up door of FIG. 12 moving upwards and downwards. By choosing springs 282 and 284 based on their spring constants, the movement of the spring sliding mechanism can be predicted and accounted for. For example, in one embodiment the double acting spring sliding mechanism 280 includes a first spring 282 that is stronger than the second spring 284 so that the first unit 258 begins to stretch before the second unit 260 begins to stretch.

The second ends 298 and 300 of the springs 284 and 282 are anchored to cross bars 302 and 304 fixed to units 260 and 258, respectively. In the depicted embodiment the bars 290 and 292 have a square cross-section that fits within the square cross-section of units 260 and 258. The first ends 294 and 296 of the springs 284 and 282 are attached to bars 290 and 292. It should be appreciated that any other shaped cross-sections are possible and that in some embodiments the cross-section of the bars need not be the same shape as the cross-section of the units.

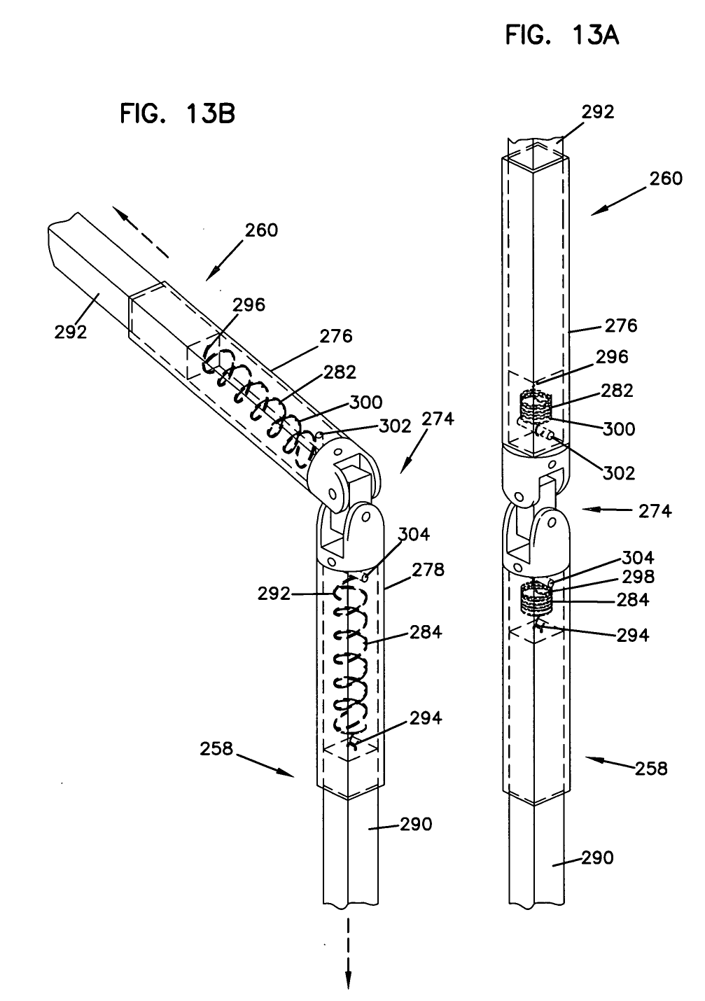

Referring to FIGS. 14-17, an example of a sealing assembly that can be used to form a seal around the peripheral top and side edge of the service door panel is shown. Sealing the cargo areas of the truck is particularly advantageous when the temperature within the cargo areas is controlled. For example, sealing the cargo area of a refrigerated truck is advantageous because the seal restricts the airflow between the inside and outside of the cargo area thereby minimizing the energy wasted. The seals are advantageous for numerous other reasons as well, including for example, for keeping the cargo area of the truck free of dust or to prevent contamination of the cargo and to prevent undue vibration of the roll-up door against the truck's frame which can cause premature wear.

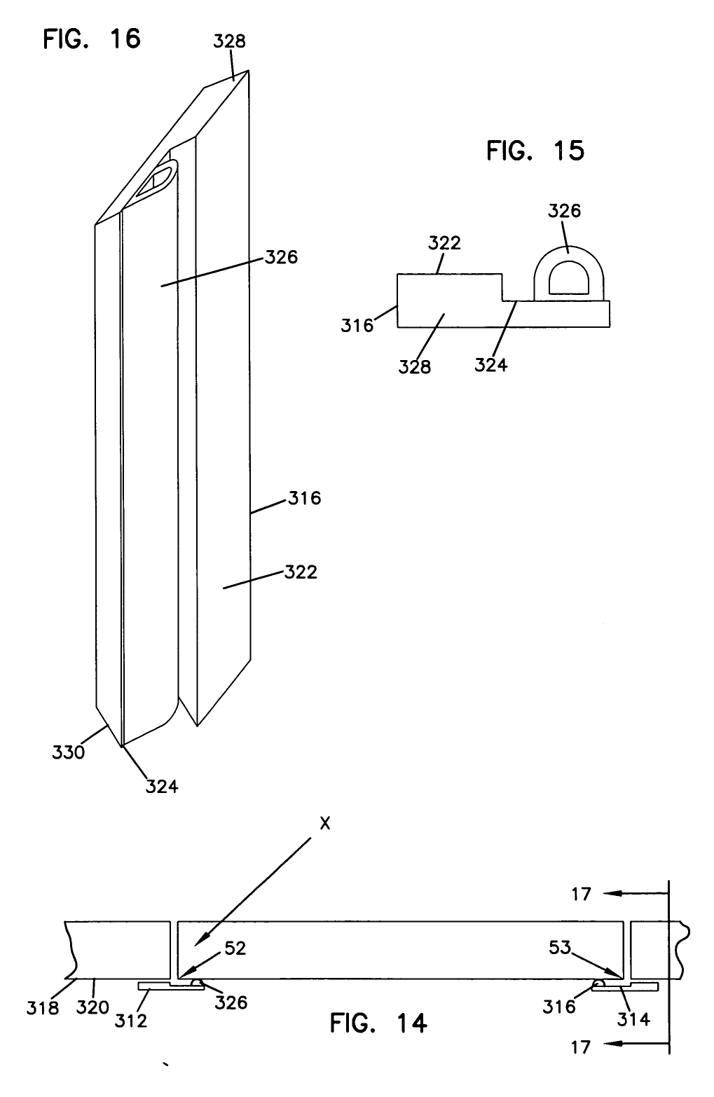

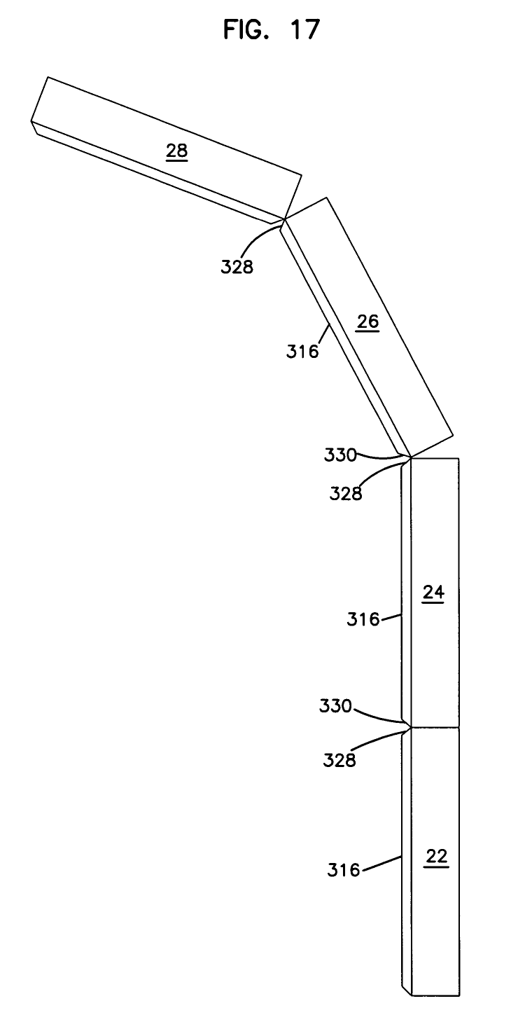

The sealing assembly includes two columns 312 and 314 of sealing plates 316 attached to the inside edges 52 and 53 adjacent the free end 63 and the pivot end 67 of the service door 40. The sealing plates 316 include a first surface 322 configured to attach to inside surface 318 of the non-service door portion 320 of the rollup door 12. In the depicted embodiment, the sealing plates 316 include a second surface 324 offset and parallel to the first surface 322 that is configured to attach to a gasket 326. The offset can be achieved by stacking materials together to form the sealing plate as shown in FIG. 16 or extruding sealing plate 316 to include such an offset as shown in FIG. 15. In the depicted embodiment the sealing plates 316 are mechanically fixed to the roll-up door via fasteners and the gasket 326 is glued to the sealing plate 316. It should be appreciated that many other suitable configurations of the sealing plate 316 exist and many other alternative means of connecting the sealing plate 316, the roll-up door 12, and gasket 326 are possible.

At each end of the sealing plate 316 are angled surfaces 328 and 330 that prevent the ends of the sealing plate 316 from interfering with each other as the roll-up door 12 moves upward and downward. In the depicted embodiment, the angle of the angled surfaces 328 and 330 relative to the first surface 322 is less than 45 degrees. It should be appreciated that in alternative embodiments any suitable angle including zero and 90 degrees is possible.

Referring generally to the description above, a method of manufacturing or retrofitting a roll-up door is provided. The method of manufacturing and retrofitting the roll-up door includes a number of common steps. For example, some of the steps in common may include pivotally connecting the pivot side 67 of the service door 40 to the non-service door portion of the roll-up door; connecting a free end securing assembly 54 to the service door; connecting a transverse support mechanism 92 to the inside surface of the service door 40; connecting a base plate 104 across the bottom most panel 20; installing the sealing assembly; and adjusting free end securing member 54 to ensure proper alignment. In the embodiments illustrated above, many of the above steps are illustrated in greater detail. For example, the step of pivotally connecting the pivot side 67 of the service door 40 to the non-service door portion of the roll-up door is shown to include the step of hinging the panels of the service door to the adjacent panels of the roll-up door to allow the service door to pivot about a vertical axis. The step of connecting a free end securing assembly 54 to the service door 40 is shown to include the step of securing via fasteners the free end securing assembly 54 to the free side 63 of the outside surface of the service door 40. It should be appreciated that not all of the above steps are necessary in the retrofitting or manufacturing process. In addition, many additional steps and sub-steps are also consistent with the principles of the invention, as illustrated above.

The method of retrofitting the roll-up door 12 to include the service door may also include the steps of cutting the panels of the service door 40 into the roll-up door; rearranging and adding hinges to accommodate the panels of the service door 40; removing the original seal at the lower edge of the service door prior to attaching the base plate across the bottom panel 20 of the roll-up door. It should be appreciated that many additional steps or sub-steps or different steps may be included in the retrofitting process; for example, the step of capping the cut edges with edge caps 121 may also be included. In should also be appreciated that in some embodiments the retrofitting process includes fewer steps as well.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A roll-up door including:
a first and a second sectioned panel, wherein the sectioned panels are pivotally connected about a horizontal axis;
wherein the first sectioned panel includes a first portion and a second portion, the first portion including a free end and a hinged end, the hinged end being connected to the second portion such that the first portion pivots relative to the second portion about a first vertical axis;
wherein the second sectioned panel includes a first portion and a second portion, the first portion including a free end and a hinged end, the hinged end being connected to the second portion such that the first portion pivots relative to the second portion about the first vertical axis; and
wherein the free ends of the first and second sectioned panels interlock and move together as a single unit when the roll-up door is in a down position.

2. The roll-up door according to claim 1, wherein the length of the first and second sectioned panels are substantially the same and substantially equal to the width of the roll-up door.

3. The roll-up door according to claim 2, wherein the length of the first portions of the first and second sectioned panels are substantially the same and substantially equal to the width of a service door within the roll-up door.

4. The roll-up door according to claim 3, wherein the width of the first and second sectioned panels partially determines the height of the service door.

5. The roll-up door according to claim 1, wherein a first bar segment is connected to the free end of the first sectioned panel and a second bar segment is connected to the free end of the second sectioned panel, and wherein an end of the first bar segment engages an end of the second bar segment when the roll-up door is in a down position.

6. A free end locking assembly for a service door in a roll-up door, the locking assembly comprising:
a bar including a first connector at a first end and a second connector at the second end, the first connector being configured to mate with the second connector such that the first end of the bar is configured to mate with a second end of an identical bar and the second end of the bar is configured to mate with a first end of an identical bar, the bar being configured to be attached to a free end of a service door.

7. The locking assembly according to claim 6, wherein the first connector and the second connector are configured to geometrically fit together.

8. The locking assembly according to claim 7, wherein the first connector includes a guide member configured to self align the first end of the bar with the second end of an identical bar.

9. The locking assembly according to claim 8, wherein the bar is a hollow bar having an inner and an outer diameter, the first connector includes a boss having a base including an outer diameter that is less than an inner diameter of the hollow bar.

10. The locking assembly according to claim 9, wherein the boss includes a neck portion configured to align the boss with the second end of an identical bar.

11. The locking assembly according to claim 10, wherein the position of the boss is adjustable relative to the hollow portion of the bar, and the position of the boss can be fixed by tightening a setscrew.

12. The locking assembly according to claim 6, further comprising an over the center latch that is configured to connect the bar to the outer surface of the service door.

13. The locking assembly according to claim 12, wherein the latch comprises:
a base, the base being configured to attach to the outer surface of a service door;
an arm, the arm extending from the base and configured to attach to the bar; and
a catch, the catch configured to attach to the roll-up door and engage the base when the latch is in a locked position.

14. The locking assembly according to claim 13, wherein the latch and bar are configured such that the service door is locked in the closed position when the bar is biased towards the outer surface of the service door, and the service door is unlocked when the bar is biased away from the outer surface of the service door.

15. A method of manufacturing or retrofitting a roll-up door having a service door therein, comprising the steps of:
cutting a service door into a roll-up door, the service door having a free edge and a hinged edge;
pivotally connecting the hinged edge of the service door to the roll-up door; and
connecting a locking assembly to an outside surface of the service door adjacent the free edge.

16. The method of claim 15, further comprising the step of:
selecting bar members of the locking assembly having lengths that are substantially the same as the width of panel of the roll-up door and connecting the selected bars to the panels.

17. The method of claim 16, further comprising the step of:
adjusting guide members located at an end of the bars to ensure that the bars self align and engage as the roll-up door moves up and down.

20. The method of claim 16, further comprising the step of:
attaching a latching member to the bar and to the service door such that the service door is held securely shut when the bar is in a first position and released when the bar is in a second position.

21. The method of claim 15, further comprising the step of:
connecting a support member below and across the lower end of the roll-up door.

22. The method of claim 21, wherein the support member includes a first end, a second end, and a mid portion, the first and second ends being aligned and the mid portion being offset from the first and second end, the mid portion being positioned below the service door.
